(19) United States
(12) Patent Application Publication
(10) Pub. No.: US 2026/0158452 A1
(43) Pub. Date: Jun. 11, 2026

(54) MEMBRANE BACKERS AND MEMBRANES FOR LIQUID FILTERS

(71) Applicant: DelStar Technologies, Inc., Alpharetta, GA (US)

(72) Inventors: Andrew G. Platt, Middletown, DE (US); Lenny Pompeo, Alpharetta, GA (US); Thomas Adjei, Alpharetta, GA (US)

(21) Appl. No.: 19/180,400

(22) Filed: Apr. 16, 2025

Related U.S. Application Data
(60) Provisional application No. 63/635,000, filed on Apr. 17, 2024.

(51) Int. Cl. B01D 69/10; B01D 61/02; B01D 63/10; B01D 69/12

(52) U.S. Cl. CPC B01D 69/1071; B01D 61/025; B01D 63/10; B01D 69/1216

(57) ABSTRACT

The present disclosure provides membrane backers, membranes, and filters, such as liquid filters, water filters, reverse osmosis filters, nano-filtration (NF) devices and the like. A membrane backer includes a support layer comprising spunbond fibers. The support layer has a ratio of a maximum pore diameter to a mean flow pore diameter (i.e., pore size distribution (PSD)) of about 8.0 to about 1.0, or about 3.0 to about 1.0. Reducing the PSD of the support layer creates a more uniform structure and a controlled porosity that allows for high quality casting to a membrane, while providing consistent flow rates therethrough. The support layer may include continuous fibers that create a smoother surface for casting the layer onto a membrane. The support layer has a sufficient tensile strength to provide mechanical support and stability to reduce fouling and inhibit premature membrane failure and sufficient elongation characteristics to facilitate handling and casting of the layer onto a membrane.

### CROSS-REFERENCE TO RELATED APPLICATIONS

This application claims the benefit of U.S. Provisional Application Ser. No. 63/635,000, filed Apr. 17, 2024, the complete disclosure of which is incorporated herein by reference.

### BACKGROUND

Reverse osmosis (RO) and nano-filtration (NF) membranes are commonly used as a filtration method to remove many types of dissolved solids, such as sediment, salt, and other contaminants, from solutions by applying pressure to the solution when it is on one side of a selective membrane. The solute is retained on the pressurized side of the membrane and the pure solvent is allowed to pass to the other side.

Osmosis occurs when two solutions with different concentrations are separated by a semipermeable membrane. In RO water purification systems, the osmotic pressure is overcome using hydraulic pressure, which is applied using a pump to the concentrated side. Water is then driven from the concentrated solution and collected downstream of the membrane. RO membrane sizes are typically selected based on their water volume production rate and the desired hourly or daily rate of water to be used in the system.

Most commonly used RO membranes typically comprise a thin film composite (TFC) consisting of three layers: a polymer support layer or web, a micro porous polysulfone interlayer and an ultra-thin polyamide barrier layer on the top surface. The porous interlayer is very thin material without mechanical integrity and, therefore, require mechanical support materials to withstand the pressures applied during the filtration process. The polymeric support webs or membrane backers are typically casted directly onto the porous interlayer to provide this support.

Key performance characteristics for membrane backers in these applications are smooth surfaces with little to no defects and substantially uniform properties, such as basis weight, thickness, and a relatively narrow pore size distribution. In addition, the pore rating or mean flow pore size impacts the functional attributes of the membrane backer, including flow rate and throughput.

### SUMMARY

Membrane backers, membranes and filters, and methods for manufacturing the same are provided herein. The membrane backers may be configured for use in a variety of applications, including but not limited to, liquid filters, water filters, reverse osmosis filters, microfiltration (MF), ultrafiltration (UF) and nano-filtration (NF) devices and the like.

In one aspect, a membrane backer includes a support layer comprising spunbond fibers. The support layer has a ratio of a maximum pore diameter to a mean flow pore diameter (i.e., pore size distribution (PSD)) of about 8.0 to about 1.0.

In various embodiments, the PSD is about 3.0 to about 1.0, or about 2.5 to about 1.0 or about 1.5 to about 1.0. Reducing the PSD of the support layer creates a more uniform structure and a controlled porosity that allows for high quality casting to a membrane, while providing consistent flow rates therethrough.

In various embodiments, the fibers are spunbond by bonding together extruded spun filaments to create the web. The spunbond process may be more cost effective than other methods of producing the fibers and may create manufacturing efficiencies, such as higher throughput, lower maintenance, less space, increased automation, less scrap ratio, and a continuous manufacturing process (i.e., 24/7).

The spunbond fibers may be staple fibers or continuous fibers. In an exemplary embodiment, the fibers are continuous. Providing continuous fibers inhibits or prevents standing fibers from extending above the membrane surface which may occur with staple or discontinuous fibers, thereby creating a smoother surface for casting the layer onto a membrane. In addition, continuous fibers may provide additional advantages, such as increased elongation percentage, which makes the support layer more flexible and allows it to endure greater deformation before breaking. This flexibility can contribute to a longer lifespan for the filter, as it may be able to withstand more stress without losing its structural integrity.

In various embodiments, the fibers are hydroentangled or needled to increase the uniformity of certain parameters, such as pore size, thickness, and basis weight. In certain embodiments, the fibers are subject to microcreping and/or unidirectional drawing and then flat calendered to reduce the PSD, optimize thickness, uniformity, and porosity. The fibers may also be cross-linked to further reduce the PSD.

In various embodiments, the membrane backer has a maximum pore diameter of about 25 microns or less, or about 15 microns or less. The backer has a minimum pore diameter of about 2 microns or less, or about 1 micron or less. The backer has a mean flow pore size diameter of about 10 microns or less, or about 5 microns or less. Providing lower maximum pore diameters reduces the amount of membrane solution bleed through the media.

The fibers may have a diameter of less than 30 microns, or about 20 microns or less or about 10 microns or less, or about 5 microns or less.

The support layer may have a basis weight of about 75 gsm to about 100 gsm, or about 75 gsm to about 90 gsm. The thickness of the support layer is preferably about 3.5 mils to about 4.5 mils, or about 3.8 mils to about 4.2 mils.

The support layer has a sufficient tensile strength to provide mechanical support and stability to reduce fouling and inhibit premature membrane failure. In various embodiments, the support layer has a machine direction (MD) tensile strength of about 10 kg/in or greater, or about 13 kg/in or greater or about 15 kg/in or greater or about 18 kg/in or greater, and a cross direction (CD) tensile strength of about 4.0 kg/in or greater or about 7.0 kg/in or greater, or about 9.0 kg/in or greater.

The support layer also has sufficient elongation to facilitate handling and casting of the layer onto a membrane. In addition, the elongation of the support layer may provide other advantages, such as flexibility, durability, and overall performance of the filter. In various embodiments, the MD elongation percentage of the support layer is about 10% or greater, or about 25% or greater, or about 45% or greater and the CD elongation percentage is about 20% or greater, or about 40% or greater or about 60% or greater, or about 80% or greater.

The fibers may be artificial or natural. Suitable materials for the fibers include, but are not limited to, high-density polyethylene (HDPE), polyethylene terephthalate (PET), polypropylene (PP), polylactic acid (PLA). thermoplastic polymers, Nylon, polybutylene terephthalate (PBT), thermoplastic elastomer (TBE), polyphenylene sulfide (PPS), polyvinylidene fluoride (PVDF) and any combination thereof. Other conventional fiber materials are contemplated. Other conventional fiber materials are contemplated. In an exemplary embodiment, the fibers comprise PET.

In certain embodiments, the fibers are monocomponent. In other embodiments, the fibers comprise thermally splitable fibers. In other embodiments, the fibers comprise multicomponent or biocomponent fibers. The support layer may comprise combinations of these types of fibers. The biocomponent fibers may comprise any suitable configuration, such as such as core/sheath with a concentric or eccentric core, side by side, segmented pie, island in the sea, hollow bicomponent fiber. hollow segmented pie, trilobal bicomponent fiber, mixed fibers, striped fibers, conductive fibers and the like. The bicomponent fiber may have a solid or a hollow core. For example, a segmented pie or side by side fiber may include a hollow core.

In various embodiments, the membrane backer comprises a second layer of fibers in contact with the support layer. The second layer of fibers improves the overall uniformity and quality of the backer and increases the ability to control the fiber size distribution. The second layer of fibers can be manufactured by any suitable method, including, without limitation, meltblown, spunbond or spunlace, bicomponent spunbond, heat-bonded, carded, air-laid, wet-laid, extrusion, co-formed, needlepunched, stitched, hydraulically entangled or the like. In an exemplary embodiment, the second layer of fibers comprises meltblown fibers.

In another aspect, a filter membrane is provided comprising the backer described above. In one embodiment, the filter membrane comprises a porous layer in contact with the support layer. The porous layer may comprise any suitable material for the specific application, such as polysulfone or the like.

The membrane may further comprise a filter media in contact with the porous layer such that the porous layer is disposed between the filter media and the support layer.

In embodiments, the membrane has an average burst pressure of about 12 psi to about 40 psi, or about 16 psi to about 40 psi, or about 35 psi to about 40 psi.

In embodiments, the membrane has a bubble point of about 4.5 to about 13, or about 9 to about 13, or about 12 to about 13.

In embodiments, the support layer and the porous layer together have a width of about 30 microns to about 80 microns, or about 50 microns to about 80 microns, or about 65 microns to about 75 microns or about 70 microns. The membrane (including the support layer, porous layer and filter media) has a width of about 100 microns to about 200 microns, or about 140 microns to about 200 microns, or about 150 microns to about 180 microns, or about 160 microns to about microns.

In embodiments, the membrane has an average flux of about 12 to about 20 gallons per square foot/day (gfd), or about 13 to about 16 gfd. The membrane has an average particle rejection percentage of at least about 99.5%, or at least about 99.6% or at least about 99.7%.

In another aspect, a liquid filter is provided with one of the membranes described above. The liquid filter may comprise, for example, a water filter, a reverse osmosis filter, or a microfiltration (MF), ultrafiltration (UF) and nano-filtration (NF) device.

In another aspect, a reverse osmosis (RO) filter is provided comprises the membranes described above. The RO filter may further comprise first and second membranes each comprising a membrane backer that includes a support layer comprising continuous spunbond fibers. The support layer has a ratio of a maximum pore diameter to a mean flow pore diameter (i.e., pore size distribution (PSD)) of about 3.0 to about 1.0.

In embodiments, the RO filter has an average flux of about 60 to about 100 gallons per square foot/day (gfd), or about 70 to about 90 gfd, or about 75 to about 80 gfd. The RO filter has an average particle rejection percentage of at least about 99%, or at least about 99.5% or at least about 99.7%.

The RO filter may further comprise a mesh layer disposed between the first and second membranes. The mesh layer may comprise, for example, a permeate water carrier or mesh spacer. The mesh layer may comprise any suitable material, such as a knit fabric.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 is a cross-sectional view of a membrane;

FIG. 2 is a cross-sectional view of first and second membranes with a permeate collection filter therebetween;

FIG. 3 is a perspective view of a reverse osmosis membrane;

FIGS. 4A and 4B are graphs illustrating the basis weights of certain samples of membrane backers provided herein;

FIGS. 5A and 5B are graphs illustrating the thicknesses of certain samples of membrane backers provided herein;

FIGS. 6A and 6B are graphs illustrating the air permeability of certain samples of membrane backers provided herein;

FIGS. 7A and 7B are graphs illustrating the MD tensile strength of certain samples of membrane backers provided herein;

FIGS. 7C and 7D are graphs illustrating the CD tensile strength of certain samples of membrane backers provided herein;

FIGS. 8A and 8B are graphs illustrating the MD elongation percentage of certain samples of membrane backers provided herein;

FIGS. 8C and 8D are graphs illustrating the CD elongation percentage of certain samples of membrane backers provided herein;

FIGS. 9A and 9B are graphs illustrating the MD modulus of certain samples of membrane backers provided herein;

FIGS. 9C and 9D are graphs illustrating the CD modulus of certain samples of membrane backers provided herein;

FIGS. 10A and 10B are graphs illustrating the maximum pore size of certain samples of membrane backers provided herein;

FIGS. 11A and 11B are graphs illustrating the mean flow pore size of certain samples of membrane backers provided herein; and

FIGS. 12A and 12B are graphs illustrating the minimum pore size of certain samples of membrane backers provided herein.

### DESCRIPTION OF THE EMBODIMENTS

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Membrane backers, membranes and filters, and methods for manufacturing the same are provided herein. The membrane backers may be configured for use in a variety of applications, including but not limited to, liquid filters, water filters, reverse osmosis (RO) filters, microfiltration (MF), ultrafiltration (UF) and nano-filtration (NF) devices and the like.

The membrane backers described herein include a support layer comprising spunbond fibers that may be created, for example, by bonding together extruded spun filaments to create the web. The spunbond process may be more cost effective than other methods of producing the fibers and may create manufacturing efficiencies, such as higher throughput, lower maintenance, less space, increased automation, less scrap ratio, and a continuous manufacturing process (i.e., 24/7).

The spunbond fibers may be staple fibers or continuous fibers. In an exemplary embodiment, the fibers are continuous. Providing continuous fibers inhibits or prevents standing fibers from extending above the surface, thereby creating a smoother surface for casting the layer onto a membrane.

The fibers contemplated may have many shapes in cross-section, including without limitation, circular, kidney bean, dog bone, trilobal, barbell, bowtie, star, Y-shaped, and others. These shapes and/or other conventional shapes may be used with the embodiments to obtain the desired performance characteristics. The fibers stay connected to each other through thermal bonds and chemical bonds, by being entangled with one another, through the use of binding agents, such as adhesives, or the like.

The fibers may be artificial or natural. Suitable materials for the fibers include, but are not limited to, high-density polyethylene (HDPE), polyethylene terephthalate (PET), polypropylene (PP), polylactic acid (PLA). thermoplastic polymers, Nylon, polybutylene terephthalate (PBT), thermoplastic elastomer (TBE), polyphenylene sulfide (PPS), polyvinylidene fluoride (PVDF) and any combination thereof. Other conventional fiber materials are contemplated. Other conventional fiber materials are contemplated. In an exemplary embodiment, the fibers comprise PET.

The fibers may be naked (e.g., zero spin finish) or the fibers may include a spin finish. The spin finish may include but is not limited to, lubricants, emulsifiers, antistats, anti-microbial agents, cohesive agents, and wetting agents. Other organic liquids, such as alcohols or blends of organic liquids may be added to the spin finish.

The support layer has a ratio of a maximum pore diameter to a mean flow pore diameter (i.e., pore size distribution (PSD)) of about 8.0 to about 1.0. Reducing the PSD of the support layer creates a more uniform structure and a controlled porosity that allows for high quality casting to a membrane, while providing consistent flow rates therethrough. In various embodiments, the PSD is about 3.0 to about 1.0, or about 2.5 to about 1.0 or about 1.5 to about 1.0.

In various embodiments, the membrane backer has a maximum pore diameter of about 25 microns or less, or about 15 microns or less. The backer has a minimum pore diameter of about 2 microns or less, or about 1 micron or less. The backer has a mean flow pore size diameter of about 10 microns or less, or about 5 microns or less.

The fibers may have a diameter of less than 30 microns, or about 20 microns or less or about 10 microns or less, or about 5 microns or less. Reducing the fiber size facilitates the creation of a more uniform support layer, with a relatively narrow PSD.

The support layer may have a basis weight of about 75 gsm to about 100 gsm, or about 75 gsm to about 90 gsm. The thickness of the support layer is preferably about 3.5 mils to about 4.5 mils, or about 3.8 mils to about 4.2 mils.

The support layer has a sufficient tensile strength to provide mechanical support and stability to reduce fouling and inhibit premature membrane failure. In various embodiments, the support layer has a machine direction (MD) tensile strength of about 10 kg/in or greater, or about 13 kg/in or greater or about 15 kg/in or greater or about 18 kg/in or greater, and a cross direction (CD) tensile strength of about 4.0 kg/in or greater or about 7.0 kg/in or greater, or about 9.0 kg/in or greater.

The MD direction is used herein as the direction in which the material is produced or moves through the machine during the manufacturing process. The machine direction typically runs parallel to the flow of the material through the machine, and it often influences properties such as strength and stiffness. The CD direction is the direction perpendicular to the machine direction (i.e., across the width of the material as it moves through the machine).

The support layer also has sufficient elongation to facilitate handling and casting of the layer onto a membrane. In addition, the elongation of the support layer may provide other advantages, such as flexibility, durability, and overall performance of the filter. In various embodiments, the MD elongation percentage of the support layer is about 10% or greater, or about 25% or greater, or about 45% or greater and the CD elongation percentage is about 20% or greater, or about 40% or greater or about 60% or greater, or about 80% or greater.

In some embodiments, the fiber layer may comprise a “high loft” nonwoven material comprising spunbond or air through bonded carded nonwoven fibers. As used here in the term “high loft” means that the volume of void space is greater than the volume of the total solid. In air through bonded carded nonwoven fibers, the loftiness of a fiber layer can be controlled by various means known to those of skill in the art. For example, loftiness can be increased by applying less compression force onto the media during bonding. In other embodiments, the loftiness may be increased by using eccentric biocomponent fibers.

In certain embodiments, the fibers are monocomponent. In other embodiments, the fibers comprise biocomponent fibers. The biocomponent fiber may comprise any suitable configuration, such as such as core/sheath with a concentric or eccentric core, side by side, segmented pie, island in the sea, hollow bicomponent fiber. hollow segmented pie, trilobal bicomponent fiber, mixed fibers, striped fibers, conductive fibers and the like. The bicomponent fiber may have a solid or a hollow core. For example, a segmented pie or side by side fiber may include a hollow core.

In one embodiment, the polymer is melted and fed into an extruder, and forced through a spinneret, cooled, and then advanced along a conveyor belt to form a continuous web. The spinneret is preferably designed to produce filaments or fibers having a diameter of about 10 microns or less, or about 5 microns or less. In various embodiments, the fibers are hydroentangled, spun laced or needled to increase the uniformity of certain parameters, such as pore size, thickness, and basis weight. In an exemplary embodiment, the loose fibers are passed through a series of high-pressure water jets that forcefully spray water onto the fibers. These jets entangle the fibers together, creating a more cohesive and uniform support layer.

In certain embodiments, the fibers are subject to microcreping and/or unidirectional drawing and then flat calendered to reduce the PSD, optimize thickness, uniformity, and porosity. The fibers may also be cross-linked to further reduce the PSD.

In other embodiments, the fibers comprise thermally splitable fibers to further reduce the fiber size of at least some components of the fibers within the filter media. The bicomponent or thermally splitable fibers each have at least first and second components. In certain embodiments, at least some of the first components are separated from the second component(s) during carding, spun bonding and/or thermal bonding. The separated first component(s) may have a substantially smaller size than the bicomponent fiber.

In some embodiments, the bicomponent fiber has a size of about 1.5 to about 18 dtex, or about 1.5 to about 5.6 dtex. The term dtex as used herein means the mass in grams for every 10,000 meters of fiber. The first components may separate or split from the second components to produce substantially smaller fibers or filaments or segments. After separation or splitting, for example, at least some of the first component(s) have a size of less than about 1.5 dtex, or about 0.005 to about 0.05 dtex, or about 0.01 to about 0.02 dtex. The first component may have a maximum dimension of about 1-10 microns, or about 3-5 microns.

The first component comprises a thermoplastic elastomer material and a thermoplastic material and has a higher shrinkage ratio/percentage/rate than the second component such that at least a portion of the first component separates from the second component upon the application of heat or thermal energy to the fiber.

In embodiments, the melting point of the first component is about 50° C. less than the melting point of the second component. The MFR of the first and second components are preferably similar to each other. In embodiments, the MFR of these components is about 10-50 g/10 min.

In embodiments, the thermoplastic elastomer material of the first component is less than about 25% by weight of the first component, or about 10% to about 20% by weight of the first component, preferably about 15%.

Suitable thermoplastic elastomer materials for the first component include a styrene block copolymer (SBS, SIS, SEBS), an olefin block polymer, a thermoplastic polyolefin elastomer (TPO), a thermoplastic polystyrene elastomer (TPS), a polyester copolymer, polyester elastomer (e.g., Hytrel®), a thermoplastic vulcanizate (TPV), a polyamide elastomer (PEBAX), a thermoplastic polyurethane (TPU), an ionomer, an ethylene vinyl acetate (EVA), a propylene-based elastomer, a propylene-ethylene copolymer, an ethylene octane copolymer and combinations thereof. In a preferred embodiment, the thermoplastic elastomer material comprises an olefin block copolymer, such as Vistamaxx™ 7020BF, manufactured by Exxon (a propylene ethylene copolymer).

In terms of selection of polymer blends, miscible resins are blended with similar materials. For example, PP may be mixed with olefin block copolymer based elastomer, and polyamide elastomer is blended with a polyamide resin, and the polyester elastomer resin is blended with PET or PBT. In other embodiments, any elastomer could be blended any thermoplastic polymer resin as long as they are miscible. For instance, to further increase shrinkage, PLA can be blended with olefin block copolymers.

Suitable thermoplastic materials for the first component include polyolefins, polyethylene (PE), polypropylene (PP), blends of PP and PE, PBT, PET, PLA, PA, CoPET and combinations thereof. In a preferred embodiment, the thermoplastic material comprises PP.

The second component may comprise any suitable material having a higher melting point and/or a similar melt flow rate (MFR) to the first component. Suitable materials for the second component include, but are not limited to, polyolefins, polyethylene (PE), polypropylene (PP), blends of PP and PE, PBT, PET, PLA, polyamides, and combinations thereof.

The ratio of weight between the first and second components may be about 20/80 to about 80/20. In certain embodiments, the second component has a greater weight percentage than the first component. In an exemplary embodiment, the first component has a weight percentage of about 50% of the bicomponent fiber, or about 40% or about 30% or about 20%.

In various embodiments, the membrane backer comprises a second layer of fibers in contact with the support layer. The second layer of fibers improves the overall uniformity and quality of the backer and increase the ability to control the fiber size distribution. The second layer of fibers can be manufactured by any suitable method, including, without limitation, meltblown, spunbond or spunlace, bicomponent spunbond, heat-bonded, carded, air-laid, wet-laid, extrusion, co-formed, needlepunched, stitched, hydraulically entangled or the like. In an exemplary embodiment, the second layer of fibers comprises meltblown fibers.

Referring now to FIG. 1, an exemplary membrane 10 for a liquid filter, such as a reverse osmosis filter, will now be described. Membrane 10 comprises a backer 40 and a porous layer 20 in contact with backer 40. In an exemplary embodiment, porous layer 20 comprises a polyether sulfone or similar material. Backer 40 may comprise any of the membrane backers described above. Layer 20 may be bonded to backer 40 in any suitable manner known by those skilled in the art. In some embodiments, membrane 10 further comprises a third barrier layer or a filter media 30 in contact with layer 20 on the opposite side of backer 40. Filter media 30 may comprise, for example, an ultra-thin polyamide layer or other suitable filter media.

In embodiments, membrane 10 has an average burst pressure of about 12 psi to about 40 psi, or about 16 psi to about 40 psi, or about 35 psi to about 40 psi. Average burst pressure refers to the pressure at which a material, component, or system (such as a pipe, container, or membrane) is expected to fail or rupture under stress. It is typically measured in units like pounds per square inch (psi) or pascals (Pa). This is an average value derived from testing the material or system under controlled conditions, usually in a laboratory environment.

In embodiments, membrane 10 has a bubble point of about 4.5 to about 13, or about 9 to about 13, or about 12 to about 13. The bubble point refers to the temperature and pressure at which the first gas bubble forms from a liquid when the liquid is being heated or depressurized. In filters, the bubble point is the pressure required to force a liquid through the smallest pore in a porous material.

In embodiments, the support layer and the porous layer together have a width of about 30 microns to about 80 microns, or about 50 microns to about 80 microns, or about 65 microns to about 75 microns or about 70 microns. The membrane (including the support layer, porous layer and filter media) has a width of about 100 microns to about 200 microns, or about 140 microns to about 200 microns, or about 150 microns to about 180 microns, or about 160 microns to about microns.

In embodiments, the membrane has an average flux of about 12 to about 20 gallons per square foot/day (gfd), or about 13 to about 16 gfd. Average flux is a key indicator of the filter's overall performance. It helps determine whether the membrane is effectively filtering the liquid at a consistent rate. A higher average flux generally indicates a more efficient membrane that is producing more permeate per unit area. The average flux over time helps identify whether the system is operating consistently or experiencing fluctuations due to factors such as fouling, clogging, or changes in feedwater quality.

The membrane has an average particle rejection percentage of at least about 99.5%, or at least about 99.6% or at least about 99.7%. Percentage average rejection is a measure used to assess the effectiveness of a membrane filtration system, such as Reverse Osmosis (RO), Ultrafiltration (UF), or Microfiltration (MF)) in removing contaminants from the feedwater. It represents the percentage of a specific solute or particle (such as salts, organic compounds, bacteria, or other impurities) that is removed or rejected by the membrane during the filtration process. The formula for percentage average rejection is 1 minus the concentration of solute in the permeate or filtered water divided by the concentration of the solute in the incoming water (multiplied by 100).

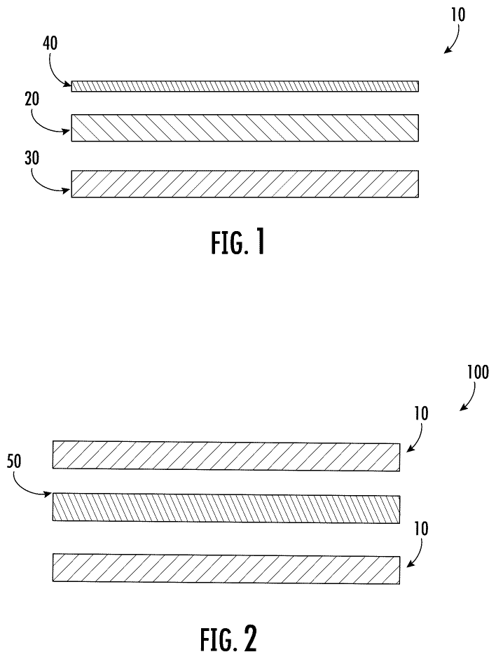

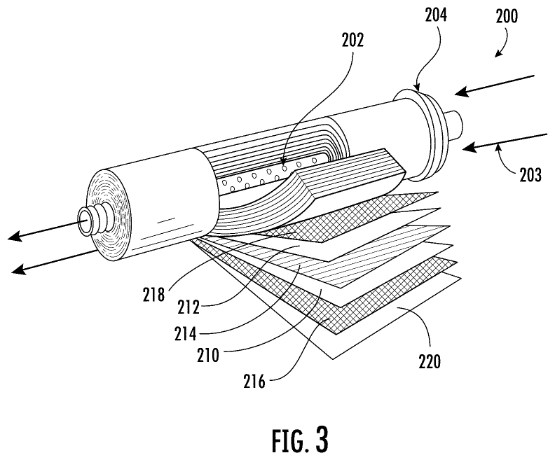

Referring now to FIG. 2, an exemplary structure 100 for use with an RO filter will not be described. Structure 100 comprises first and second membranes 10 as described above in FIG. 1 and a mesh spacer 50 disposed between membranes 10. Mesh spacer 50 may comprise, for example, a permeate water carrier comprising a knit fabric, such as “tricot” or the like. Spacer 50 inhibits membranes 10 from closing off under pressure and facilitates collection of permeate water.

Referring now to FIG. 3, a reverse osmosis (RO) filter 200 will now be described. Filter 200 comprises a series of composite membranes packed into a spiral wound configuration by winding the membranes around a perforated central tube 202. The filter may include one composite membrane, or two or more such membranes. The membrane sheets may be adhered to each other on three sides, with an opening towards the perforate tube 202. Feed water passes through in the direction of arrows 203 and forms into a permeate as the product of the reverse osmosis filtration. The concentrate is the undesirable water that exits the membrane element. Brine seals 204 may be provides at one end of tube 202 to prevent the feed solution from bypassing around the filter element.

As shown, one of the composite membranes of filter 200 includes first and second membranes 210, 212 disposed on either side of a mesh spacer 214 (as described above in reference to FIG. 2). Filter 200 further includes first and second feed channel spacers 216, 218 disposed on either side of membranes 210, 212. Spacers 216, 218 may comprise netting material placed between the flat sheets of membranes 210, 212 to promote turbulence in the feed/concentrate stream. In an exemplary embodiment, spacers 216, 218 comprise material known as “Vexar”. Filter 200 may further comprise an outer wrap 220 that comprises fiberglass, tape, or a similar suitable material to wrap around the other elements of the RO filter when high pressures are required, e.g., for treating brackish water.

While the previous description is primarily presented with respect to liquid filters, such as RO filters, the membrane backers described herein may be used in a variety of industries, such as pulp and paper, food and beverage, steel production, industrial process fluids, municipal, automotive, power generation, semiconductor manufacturing, mining/construction, petroleum/chemical refining, medical/pharmaceutical and general manufacturing.

For example, various embodiments include fuel filters, such as diesel fuel filters, hydrocarbon fuels, gasoline fuel filters, canister fuel filters, inline fuel filters, in-tank fuel filters, cartridge fuel filters, carburetor inlet filters, pump-outlet fuel filters, spin-on fuel filters and the like.

For example, various embodiments include gas turbine and compressor air intake filters, panel filters, filter presses, rotary drum filters, water plant treatment filters, biological filters, membrane bioreactor membranes, hydrocarbon filters, diesel filters, fuel filters, hydraulic fluid filters, food and beverage filters, semiconductor filters, microfiltration membranes, downstream membrane filtration, pharmaceutical and medical filters, waste water filters, industrial process and/or municipal filters, pipelines gas turbine and compressor air intake filters, panel filters, cartridge filters, bag filters, clean-in-place (CIP) filters, battery separators and the like.

For example, various embodiments include semiconductor processing filters to filter nano-sized particles and harmful contaminants during logic and chip fabrication, including microfiltration filters with hydrophobic or hydrophilic membranes, chemical filters, CMP filters, lithography filters, process gas filters and purifiers, chemical mechanical polishing filters, electrolyte plating, wastewater filters, wet etch and clean filters, PFOA filters and the like.

For example, various embodiments include filters for the food and beverage industry for removing solid and/or liquid contaminants, such as filters for manufacturing fruit juices and soft drinks, water filters in sinks and pitchers, basket centrifuges for producing salt, disc centrifuges for separating cream from milk, water purification membranes, rotary vacuum drum filters for separating sugar juice from mud, hydro cyclones for purifying starch, disc or tubular centrifuges for refining vegetable seed oils, decanter centrifuges or filter presses for de-watering separated grains in, for example, a distillery or brewery.

For example, various embodiments include filters for use in the pharmaceutical manufacturing industry for plasma fractionation, specialty enzymes, vitamins, diagnostics, phytopharmaceuticals, red biotechnology, white biotechnology and may include filters, such as magnetic filters, bag filters, self-cleaning filters, and the like.

For example, in various embodiments, industrial filters are provided for removing solid and/or liquid contaminants from liquid process streams in refining, petrochemical, chemical, oil and gas, manufacturing paints, organic solvents, ink, petroleum and kerosene industrial water treatment, cosmetics, wineries and pharmaceuticals, including pleated filter cartridges, melt-blown filter cartridges, string wound filter cartridges, membrane filter cartridges, carbon filter cartridges, wound fiber depth style liquid filter cartridges, stainless steel filter cartridges, pleated series liquid cartridges, and other specialty filter cartridges. These filters may be rated from less than about 1 micron to about 100 microns.

For example, hydraulic filters are provided for removing particulate matter from hydraulic fluids. The hydraulic filters may be full flow or partial flow and may include, but are not limited to, oil filters, spin-on filters, return line filters, duplex filters, off-line and in-line filters and tank filters.

For example, various embodiments include municipal filters, such as filters used in water treatment plants. These filters may include, but are not limited to, screen filters, slow sand filters, disc filters, rapid sand filters, membrane filters, bag filters, membrane filters, reverse osmosis filters and the like.

For example, various embodiments include gas pipeline filters, such as turbine air filters, particulate filters, clay treater filters, amine filters, two-stage coalescer-separators, strainers, natural gas pipeline filters, Y-type filters, T-type filters, basket filters, magnetic filters, backwash filters and the like.

For example, various embodiments include power generation filters, such as hydropower generation filters, solar power generation filters, nuclear power generation filters, water filter cartridges, sintered metal filters, wedge wire filters, demister pad filters and the like.

For example, various embodiments include battery separators that serve as a mechanical barrier between the electrodes to prevent shorting while allowing for ionic transport through the electrolyte in the pores. For example, various embodiments include an alkaline battery separator, including, but not limited to, zinc-manganese dioxide (Zn/MnO2), nickel-cadmium (Ni—Cd), and nickel-hydrogen (Ni—H2) batteries. The battery separators may include a substrate comprising blends of polyvinyl alcohol (PVA) fibers and cellulose or cellulose derivatives such as rayon or lyocell.

### EXAMPLES

The applicant tested five different samples of support layers or webs of spunbond fibers. The first two samples (Sample 1 and Sample 2) were formed from fibers originally having a diameter of about 10 to about 12 microns and the next three samples (Samples 3-5) were formed from fibers originally having a diameter of about 8 to about 9 microns. The calendaring inputs were: (1) speed, ft/min: (2) Temperature® F.: between about 300 and 400; and (3) Pressure, psi: between about 100 to 300 psi. The samples were all tested with the same number of spin pack holes and fiber gaps. Samples 1 and 2 had slightly higher spinning distances (mm), higher throughput per hole (g/min), higher air pressure (bars) higher laying distance (mm) and slightly lower quenching temperatures than Samples 3-5.

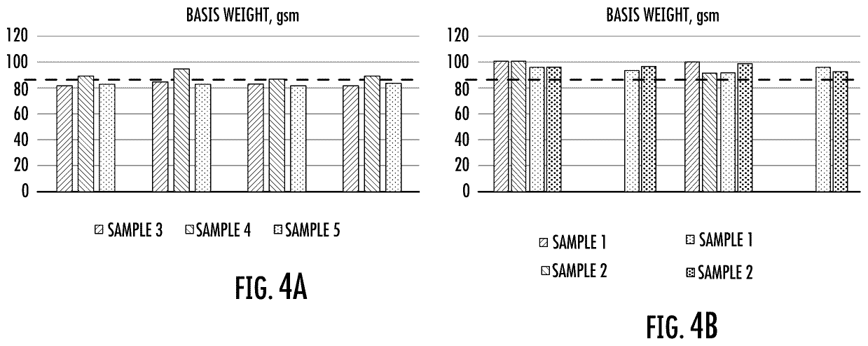

Applicant tested a variety of parameters of the five samples. FIGS. 4A-12B illustrate the results of this testing. Samples 3-5 are shown on the left side of each figure and Samples 1 and 2 are shown on the right side of the figures. Each sample was tested with different pressures and calendaring configurations. In each figure, the first set of samples were calendared at a lower pressure with a steel-on-steel configuration, the second set of samples were calendared at a higher pressure with a steel-on-steel configuration, the third set of samples were calendared at a higher pressure with a steel-on-composite configuration and the fourth set of samples were calendared at a higher pressure with a steel-on-composite configuration. The steel-on-steel configuration resulted in a film-feel/smoother sheet, while the steel-on-composite configuration had a rougher feel to the sheet. The pressures were in the range of about 100 to 300 psi. The samples were each tested at a higher temperature and a lower temperature; both within the range of between about 300° F. and 400° F.

FIGS. 4A and 4B illustrate the basis weight (in gsm) of the various samples with the dotted line indicating 85 gsm. As shown in FIG. 4A, Samples 3-5 all had a basis weight of about 85 gsm or about 96 gsm to about 78 gsm (shown by the dotted line) and samples 1 and 2 all had a basis weight above 85 gsm and less than about 100 gsm (see FIG. 4B).

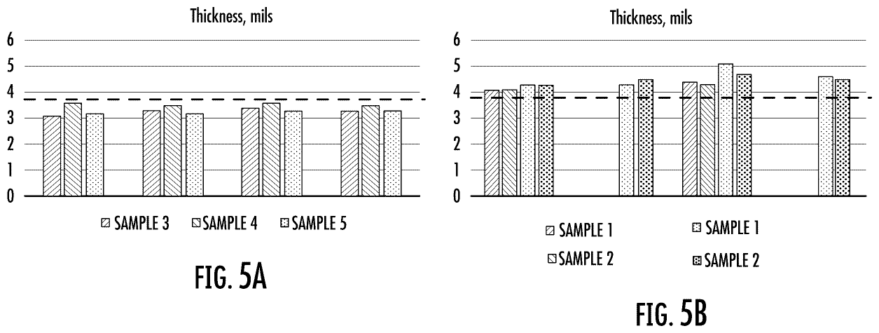

FIGS. 5A and 5B illustrate the thicknesses (in mils) of the various samples with the dotted line indicating 3.8 mils. As shown in FIG. 5A, samples 3-5 all had a thickness of 3.8 mils or less and samples 1 and 2 all had a thickness of greater than 3.8 mils and less than about 5.1 mils (see FIG. 5B).

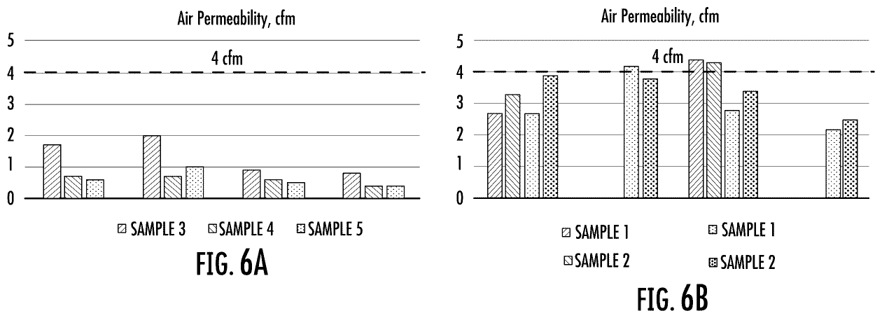

FIGS. 6A and 6B illustrate the air permeability (in cfm) of the various samples. As shown in FIG. 6A, samples 3-5 all had an air permeability of 2 cfm or less and samples 1 and 2 all had an air permeability of about 2.2 cfm to about 4.3 cfm (see FIG. 6B). Lower air permeability prevents membrane dope solution from bleeding through the media. It also allows membrane manufacturers to use low viscosity doping solution during membrane casting.

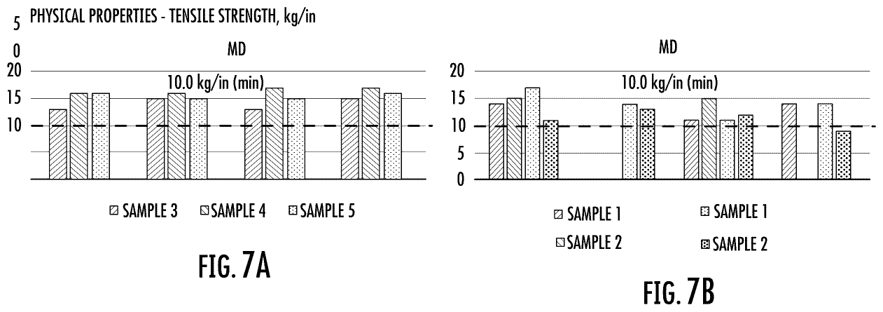

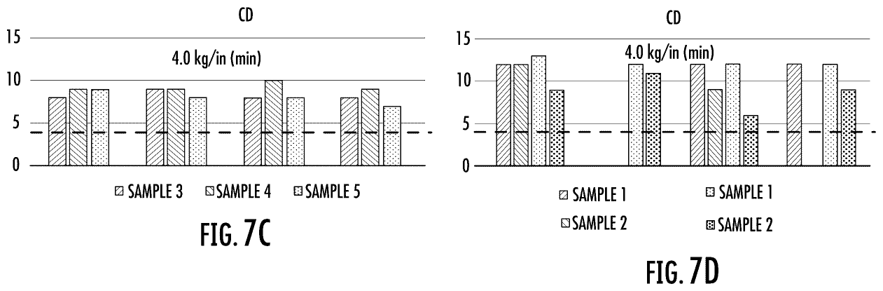

FIGS. 7A-7D illustrate the tensile strength (in kg/in) of the various samples. Samples 3-5 are shown in FIGS. 7A and 7C and Samples 1 and 2 are shown in FIGS. 7B and 7D. As shown, all of the samples (except for one of the groups from Samples 1 and 2) had a machine direction (MD) tensile strength of at least 10 kg/in. All of the samples had a cross direction (CD) tensile strength of greater than 4.0 kg/in. The tensile strengths of Samples 3-5 were more consistent and uniform than the tensile strengths of Samples 1 and 2. For example, the MD tensile strengths of Samples 3-5 ranged from about 13 kg/in to about 17 kg/in (4 kg/in distribution), whereas the MD tensile strengths of Samples 1 and 2 ranged from about 9 kg/in to about 17 kg/in (8 kg/in distribution). Similarly, the CD tensile strengths of Samples 3-5 ranged from about 7 kg/in to about 10 kg/in (3 kg/in distribution), whereas the CD tensile strengths of Samples 1 and 2 ranged from about 6 kg/in to about 13 kg/in (7 kg/in distribution). Thus, the support layers exhibited a sufficient tensile strength to provide mechanical support and stability to reduce fouling and inhibit premature membrane failure.

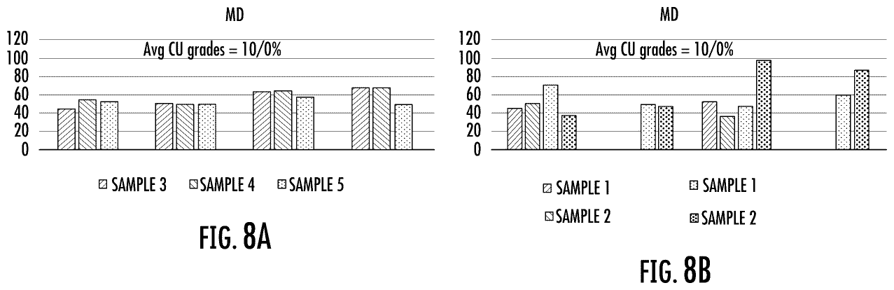

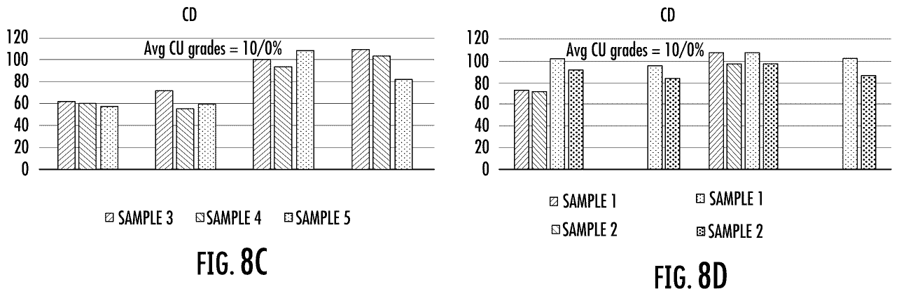

FIGS. 8A-8D illustrate the elongation percentage of the samples. As shown, Samples 3-5 had an MD elongation percentage ranging from about 45% to about 68% and Samples 1-2 had an MD elongation percentage ranging from about 37% to about 98%. Samples 3-5 had a CD elongation percentage ranging from about 56% to about 110% and Samples 1-2 had a CD elongation percentage ranging from about 72% to about 110%. Conventional membrane backers have a MD and CD elongation percentages of about 10%. Thus, the backers described herein demonstrated significantly higher elongation percentages in both the MD and CD directions, which facilitates casting the layer onto a membrane.

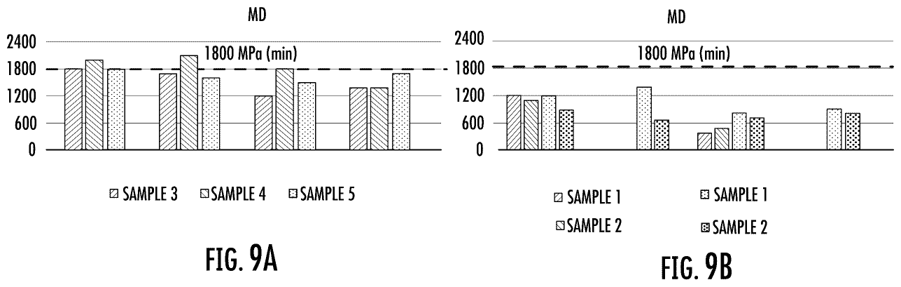

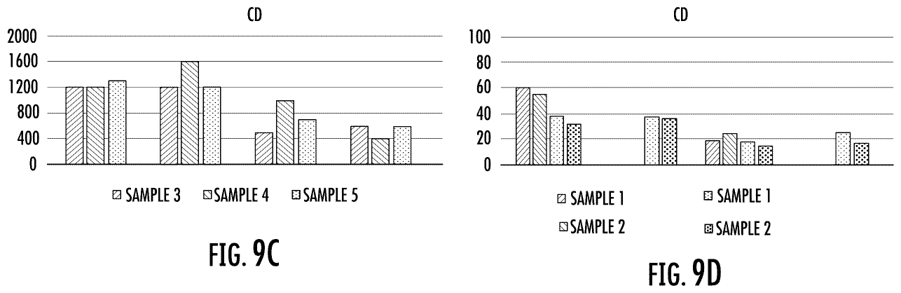

FIGS. 9A-9D illustrate the modulus of the samples in MPa. As shown, Samples 3-5 had a modulus in the MD direction ranging from about 1200 MPa to about 2100 MPa and Samples 1-2 had a modulus in the MD direction ranging from about 300 MPa to about 1300 MPa. Samples 3-5 had a modulus in the CD direction ranging from about 400 MPa to about 1600 MPa and Samples 1-2 had a modulus ranging from about 300 MPa to about 1200 MPa.

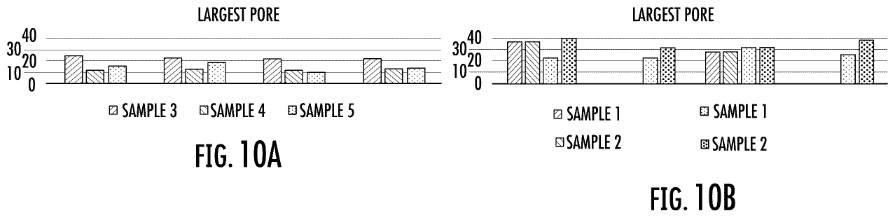

FIGS. 10A and 10B illustrate the largest or maximum pore size of the samples in microns. As shown, Samples 3-5 had maximum pore sizes of less than about 25 microns and Samples 1-2 had maximum pore sizes of less than about 40 microns. Sample 4, in particular, had a maximum pore size of about 12 microns or less.

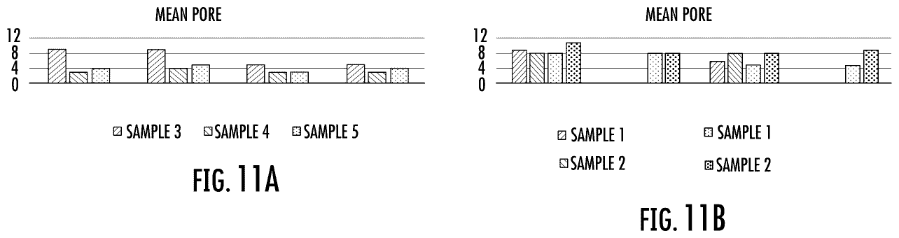

FIGS. 11A and 11B illustrate the mean flow pore sizes of the samples in microns. Samples 3-5 had mean flow pore sizes of about 9 microns or less and Samples 1-2 had mean flow pore sizes of less than 11 microns. Samples 4 and 5, in particular, had mean flow pore sizes of about 5 microns or less.

The samples exhibited a relatively narrow pore size distribution (PSD). PSD is defined herein as the ratio of the maximum pore diameter to the mean flow pore diameter. This created a more uniform structure and controlled porosity that allows for high quality casting to a membrane and allows for consistent flow rates therethrough. In particular, samples 3-5 all had a PSD of about 3.0 to about 1.0. In some cases, the PSD was 2.5 to about 1.0, or 1.5 to about 1.0. The pore size of Samples 3-5 was lower, at least in part, due to the lower air permeability after calendering.

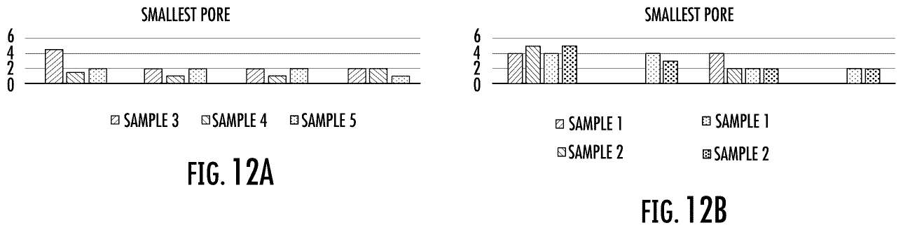

FIGS. 12A and 12B illustrate the smallest of minimum pore size of the samples in microns. As shown, Samples 3-5 had minimum pore sizes of about 2 microns or less and Samples 1-2 had minimum pore sizes of 5 microns or less. Thus, Samples 3-5 had a pore size distribution (i.e., maximum pore size minus minimum pore size) of about 23 microns or less and Samples 1-2 had a pore size distribution of about 35 microns or less. Sample 4, in particular, had a pore size distribution of 11 microns or less.

The maximum, minimum and mean flow pore sizes (as well as the pore size distribution (PSD) and the bubble point) for all samples were calculated under the procedures of ASTM F316-03 (Reapproved 2011). The gas flow across the samples was measured as a function of applied pressure across the material with a capillary flow porometer. The calculations used for determining the pore sizes were determined based on the criteria described by Aptco Technologies, NV of Nazareth, Belgium at the website www.porometer.com.

Excellent sheet formation was observed with Samples 3-5. The water jet lines were less visible in Samples 3-5 than Samples 1 and 2. the overall sheet formation after calendering showed similar or slightly better formation than conventional membranes. Polyether sulfone casting dope chemistry at 22% solids was applied to both all of the trial samples, and membrane adhesion was assessed. Good dope solution penetration was observed on steel-on-composite calendering setup webs versus steel-on-steel. The poor adhesion of the PES membrane to the web resulted in low burst pressure. Better membrane pore formation was observed with more open fiber network sheets. SEM analysis shows a distinct membrane and sheet layers where the interlocking of the membrane is poorly adhered to the PET substrate. Samples 3-5 with finer fibers demonstrated higher fiber packing density versus Samples 1 and 2.

In another example, applicant tested five different samples of support layers or webs of spunbond continuous fibers and compared the results of this testing to two samples of conventional staple wet-laid fibers. The samples were tested as follows: (1) low hydroentanglement and steel-on-steel calendering configuration with a pressure of 0 psi (“Sample 1”); (2) low hydroentanglement and steel-on-composite calendering configuration with a pressure of 250 psi (“Sample 2”); (3) higher hydroentanglement and steel-on-composite/steel-on-steel calendering configuration with a pressure of 250/0 psi (“Sample 3”); (4) higher hydroentanglement and steel-on-composite/steel-on-composite calendering configuration with a pressure of 250/0 psi (“Sample 4”); and (5) high hydroentanglement and steel-on-steel calendering configuration with a pressure of zero psi (“Sample 5”). All samples were tested at 374° F. Samples 1-5 were formed from fibers having an average diameter of about 8 to about 12 microns.

Applicant tested a variety of parameters of the five samples and the two controls, including roll length (in yards) and width (in inches), basis weight (in grams/meter2 in accordance with ASTM D374), sub weight (in lb/1300 ft2), thickness (in mils in accordance with ASTM D1777), air permeability (in cfm in accordance with ASTM D726), tensile strength (in Kg/in in accordance with ASTM D5034), elongate percentage (both MD and CD directions in accordance with ATM D4034) and elongation in cm (both MD and CD directions in accordance with ATM D4034). The result of this testing is shown below in Table 1.

TABLE 1

| Test | Sample 1 | Sample 2 | Sample 3 | Sample 4 | Sample 5 | Control 1 | Control 2 |
|---|---|---|---|---|---|---|---|
| Length | 300 | 120 | 280 | 245 | 500 | 300 | 300 |
| Width | 14.5 | 14.5 | 14.5 | 14.5 | 14.5 | 14.5 | 14.5 |
| Basis | 82.5 | 88.0 | 88.0 | 89.5 | 89.5 | 81.8 | 81.8 |
| Weight | | | | | | | |
| Sub | 21.9 | 23.4 | 23.4 | 23.8 | 23.8 | 21.9 | 23.2 |
| Weight | | | | | | | |
| Thickness | 4.0 | 3.9 | 3.7 | 4.2 | 3.6 | 3.8 | 3.8 |
| Air Perm | 2.8 | 2.5 | 2.2 | 2.9 | 2.9 | 4.2 | 2.9 |
| Tensile | 14.9 | 13.4 | 19.6 | 19.4 | 18.8 | 21.0 | 20.4 |
| (MD) | | | | | | | |
| Tensile | 8.9 | 8.3 | 10.0 | 10.6 | 9.9 | 7.1 | 7.6 |
| (CD) | | | | | | | |
| Elongation | 35 | 36.8 | 47.7 | 47.8 | 48.3 | 12.2 | 10.9 |
| % (MD) | | | | | | | |
| Elongation | 60.6 | 80.0 | 82.8 | 81.5 | 71.2 | 12.6 | 10.5 |
| % (CD) | | | | | | | |
| Elongation | 3.6 | 2.2 | 2.8 | 3.6 | 3.7 | 0.73 | 0.83 |
| (cm) | | | | | | | |
| (MD) | | | | | | | |
| Elongation | 6.2 | 4.8 | 6.1 | 6.3 | 5.4 | 0.76 | .80 |
| (cm) (CD) | | | | | | | |

As shown in Table 1, all of the samples of continuous spunbond support layers demonstrated similar characteristics and performance properties as the control support layers comprising staple wet-laid fibers. In particular, the thickness, air permeability and tensile strength in both the MD and CD directions were substantially similar. Thus, these support layers met the industry standards for these performance criteria. In addition, the elongation properties of the continuous spunbond support layers were superior to the staple wet-laid fiber support layers. For example, elongation percentage of the continuous spunbond support layers ranged between about 35 to about 48.3 in the MD direction and about 60.6 to about 82.8 in the CD direction. By contrast, the elongation percentage of the staple wet-laid fiber support layers was between about 12.2 to about 10.8 in the MD direction and about 12.6 to about 10.5 in the CD direction. Thus, the elongation percentage was between about 3 times to about 6 times greater with the continuous spunbond support layers. Similarly, the elongation (in cm) of the continuous spunbond support layers was substantially greater than the elongation (in cm) of the staple wet-laid fiber support layers.

The support layer in a filter is the material that provides mechanical strength to the filter medium. It helps maintain the filter's shape and structural integrity during use. When a filter is under load (e.g., pressure or tension), the elongation percentage indicates how much the material will stretch before breaking or failing. This can directly impact the filter's ability to function effectively in various environments, particularly under physical stress. A higher elongation percentage typically means that the material is more flexible and can endure greater deformation before breaking. This flexibility can contribute to a longer lifespan for the filter, as it may be able to withstand more stress without losing its structural integrity.

In addition, the elongation of the filter with its support layer is often considered to ensure that the filter maintains its mechanical properties even under high-pressure conditions. It ensures the filter can conform to varying fluid pressures without rupturing or allowing contaminants to pass through the filter medium. In some applications, such as filtration systems used in varying flow conditions, the elongation property can compensate for differential pressures across the filter. This allows the filter to perform better in fluctuating environments, maintaining its effectiveness while being mechanically robust.

Thus, the elongation percentage is critical because it helps evaluate the flexibility, durability, and overall performance of the filter with its support layer, ensuring that it can maintain its integrity under different physical stresses and pressure condition

Applicant conducted further testing of the above described samples and controls. A micro porous polysulfone interlayer was cast or coated to each of the support layers and then a thin film composite (TFC) of polyamide (i.e., the filter media) was applied to the polysulfone layer. The thicknesses (in microns) of each the membrane (including the polysulfone layer), the filter media and the overall composite filter media were then measured and is shown below in Table 2.

TABLE 2

| | Sample 1 | Sample 2 | Sample 3 | Sample 4 | Sample 5 | Control 1 | Control 2 |
|---|---|---|---|---|---|---|---|
| Membrane | 38.3 | 32.0 | 59.6 | 70.7 | 70.3 | 51.6 | 73.6 |
| Filter | 109.0 | 129.0 | 99.0 | 99.4 | 99.0 | 87.6 | 69.6 |
| Media | | | | | | | |
| Composite | 156.0 | 158.0 | 170.0 | 163.0 | 166.0 | 140.0 | 141.0 |

Applicant tested the average bubble point (in psi) in accordance with ASTM F3160 and the average burst pressure (in psi) in accordance with ASTM F1264 for the two controls and for certain samples. The result from this testing is shown below in Table 3.

TABLE 3

| Test | Control 1 | Control 2 | Sample 3 | Sample 4 | Sample 5 |
|---|---|---|---|---|---|
| Average | 11.6 | 10.5 | 9.8 | 12.7 | 4.7 |
| Bubble Point | | | | | |
| Average | 20.4 | 19.0 | 12.1 | 38.1 | 16.3 |
| Burst | | | | | |
| Pressure | | | | | |

As shown above, Samples 3 and 5 had a similar (although slightly lower) burst pressure as the two control samples, while Sample was clearly superior, demonstrating a burst pressure of 38.1 psi. With respect to bubble point, Samples 3 and 4 were substantially similar to the two control samples, while Sample 5 has a lower bubble point of 4.7 psi, which is advantageous for fine filtration or removing small particles because the lower bubble point indicates smaller pores.

Applicant also tested the percentage average rejection of particles in accordance with ASTM F1091 and the average flux (in gallons per square foot/day or gfd) or the amount of filtered liquid that passes through the membrane area (i.e., rate of flow of the permeate), or the mean value of this rate over the duration of the filtration process in accordance with ASTM F1091.

Average flux is a key indicator of the filter's overall performance. It helps determine whether the membrane is effectively filtering the liquid at a consistent rate. A higher average flux generally indicates a more efficient membrane that is producing more permeate per unit area. The average flux over time helps identify whether the system is operating consistently or experiencing fluctuations due to factors such as fouling, clogging, or changes in feedwater quality.

Percentage average rejection is a measure used to assess the effectiveness of a membrane filtration system, such as Reverse Osmosis (RO), Ultrafiltration (UF), or Microfiltration (MF)) in removing contaminants from the feedwater. It represents the percentage of a specific solute or particle (such as salts, organic compounds, bacteria, or other impurities) that is removed or rejected by the membrane during the filtration process. The formula for percentage average rejection is 1 minus the concentration of solute in the permeate or filtered water divided by the concentration of the solute in the incoming water (multiplied by 100).

The results of this testing are shown below in Table 4.

TABLE 4

| Test | Control 1 | Control 2 | Sample 2 | Sample 3 | Sample 4 | Sample 5 |
|---|---|---|---|---|---|---|
| Average | 15.59 | 18.6 | 14.57 | 13.85 | 13.52 | 14.59 |
| Flux | | | | | | |
| % Average | 99.74 | 99.58 | 99.55 | 99.66 | 99.5 | 99.49 |
| Rejection | | | | | | |

As shown above, Samples 2-5 of the spunbond continuous fibers were substantially equivalent to the control samples of staple wet-laid fibers in both average flux and the average percentage of rejection of contaminants.

Applicant conducted further testing on Sample 5, Control 1 and a standard control DNF element. In these tests, Sample 5 and Control 1 were fabricated into the RO membrane element, which comprised producing the membrane sheets as discussed above and then winding them into a cylindrical shape around a central perforated tube (also known as the core). Once the membrane sheets are wound, end caps were attached to both ends of the cylindrical element and feedwater was delivered through the input end cap. Applicant then tested both the average flux and the average percentage of rejection of contaminants for these RO membranes. The result of this testing is shown below in Table 5.

TABLE 5

| Test | Standard DNF | Control 1 | Sample 5 |
|---|---|---|---|
| Average Flux | 73 | 79.4 | 79.4 |
| % Average Rejection | 99.8 | 99.7 | 99.7 |

As shown above, the Sample 5 that included the spunbond continuous fibers demonstrates a percentage average rejection substantially equivalent to both the standard DNF element and the control sample. In addition, Sample 5 demonstrates an 8% increase in average flux compared to the standard DNF element. Increasing the average flux (while maintaining equivalent average rejection) increases the amount of clean water produced per unit of time without changing the physical size or number of membrane elements. This means a more efficient RO system, producing more purified water at a lower operational cost. Alternatively, this can allow for the same water output with fewer membranes or less equipment, which reduces space requirements and cost.

In addition, a higher flux reduces the need for higher pressures to achieve the same level of water output. Lower pressure means less energy required for pumping the feedwater through the system, resulting in energy savings. When flux increases without a significant increase in pressure, the system operates more efficiently, minimizing the overall energy costs associated with water treatment. In some cases, increasing flux can lead to more efficient filtration, as the system can achieve better separation of contaminants. This can be important when the system is dealing with feedwater that has high levels of contaminants, as it allows for faster processing without compromising on water quality.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

While the previous description is primarily presented with respect to filter media and liquid filters, the devices and methods disclosed herein may be readily adapted for use in a variety of other applications. For example, the filter media disclosed herein may be useful in household cleaning products, roofing and flooring products, automobile upholstery and headliners, reusable bags, wallcoverings, filtration devices, insulation and the like. In addition, the individual nanoparticles that are isolated and generated in the processes described herein may be utilized in various coatings, composites and/or additives in, for example, polymers, food packaging, flame retardants, fuel cells, batteries, capacitors, nanoceramics, lights, material fabrication, manufacturing methods, reinforcement for composites, cement and other materials, medical diagnostic applications, medical therapeutic devices or therapies, tissue engineering, such as scaffolds for bone or tissue repair, potable waters, industrial process fluids, food and beverage products, pharmaceutical and biological agents, tissue imaging, medical therapy delivery, environmental applications, such as biodegradable compounds and the like.

For example, in a first aspect, a first embodiment is a membrane backer comprising a support layer comprising spunbond fibers. A ratio of a maximum pore diameter to a mean flow pore diameter of the support layer is about 8.0 to about 1.0.

A second embodiment is the first embodiment, wherein the ratio is about 3.0 to about 1.0, or about 2.5 to about 1.0.

A third embodiment is any combination of the first two embodiments, wherein the ratio is about 1.5 to about 1.0.

A 4th embodiment is any combination of the first 3 embodiments, wherein the spunbond fibers are continuous fibers.

A 5th embodiment is any combination of the first 4 embodiments, wherein the support layer has a maximum pore diameter of about 25 microns or less.

A 6th embodiment is any combination of the first 5 embodiments, wherein the maximum pore diameter is about 15 microns or less.

A 7th embodiment is any combination of the first 6 embodiments, wherein the support layer has a mean flow pore diameter of about 10 microns or less.

An 8th embodiment is any combination of the first 7 embodiments, wherein the mean flow pore diameter is about 5 microns or less.

A 9th embodiment is any combination of the first 8 embodiments, wherein the support layer has a minimum pore diameter of about 2 microns or less.

A 10th embodiment is any combination of the first 9 embodiments, wherein the spunbond fibers have a diameter of about 10 microns or less.

An 11th embodiment is any combination of the first 10 embodiments, wherein the diameter is about 5 microns or less.

A 12th embodiment is any combination of the above embodiments, wherein the support layer has a basis weight of about 75 gsm to about 100 gsm.

A 13th embodiment is any combination of the above embodiments, wherein the support layer has a thickness of about 3.5 mils to about 4.5 mils.

A 14th embodiment is any combination of the above embodiments, wherein the support layer has a machine direction (MD) tensile strength of about 10 kg/in or greater.

A 15th embodiment is any combination of the above embodiments, wherein the support layer has a cross direction (CD) tensile strength of about 6.0 kg/in or greater.

A 16th embodiment is any combination of the above embodiments, wherein the support layer has a machine direction (MD) elongation percentage of greater than about 20.0%.

A 17th embodiment is any combination of the above embodiments, wherein the MD elongation percentage is about 30% or greater.

An 18th embodiment is any combination of the above embodiments, wherein the support layer has a cross direction (CD) elongation percentage of greater than about 20.0%.

A 19th embodiment is any combination of the above embodiments, wherein the CD elongation percentage is about 50% or greater.

A 20th embodiment is any combination of the above embodiments, wherein the spunbond fibers comprise a material selected from the group consisting essentially of high-density polyethylene (HDPE), polyethylene terephthalate (PET), polypropylene (PP), polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof.

A 21st embodiment is any combination of the above embodiments, wherein the spunbond fibers comprise PET.

A 22nd embodiment is any combination of the above embodiments, wherein the spunbond fibers comprise monocomponent fibers.

A 23rd embodiment is any combination of the above embodiments, wherein the spunbond fibers comprise splitable fibers.

A 24th embodiment is any combination of the above embodiments, wherein the spunbond fibers comprise bicomponent fibers.

A 25th embodiment is any combination of the above embodiments, further comprising a second layer of fibers in contact with the support layer.

A 26th embodiment is any combination of the above embodiments, wherein the second layer comprises meltblown fibers.

A 27th embodiment is any combination of the above embodiments, wherein the spunbond fibers are needled or hydroentangled.

A 28th embodiment is any combination of the above embodiments, wherein the spunbond fibers are calendared.

In another aspect, a first embodiment is a membrane is provided comprising the membrane backer of any combination of the first 31 embodiments.

A second embodiment is the first embodiment, further comprising a porous layer in contact with the support layer.

A third embodiment is any combination of the above embodiments, wherein the porous layer comprises polysulfone.

A 4th embodiment is any combination of the above embodiments, further comprising a filter media in contact with the porous layer such that the porous layer is disposed between the filter media and the support layer.

A 5th embodiment is any combination of the above embodiments, wherein the filter has an average flux of at least about 75 gallons per square foot/day (gfd).

A 6th embodiment is any combination of the above embodiments, wherein the average flux is at least about 79 gfd.

A 7th embodiment is any combination of the above embodiments, wherein the filter has a percentage average rejection of at least about 99.5%.

In another aspect, a filter is provided comprising the membrane backer of any combination of the above 31 embodiments.

In another aspect, a liquid filter is provided comprising the membrane backer of any combination of the above 31 embodiments.

In another aspect, a reverse osmosis filter is provided comprising the membrane backer of any combination of the above 31 embodiments.

In another aspect, a first embodiment is a membrane for use with a filter comprising a substrate and a support layer in contact with the substrate. The support layer comprises continuous spunbond fibers.

A second embodiment is the first embodiment, wherein the support layer has a machine direction (MD) tensile strength of about 10 kg/in or greater.

A third embodiment is combination any of the above embodiments, wherein the support layer has a cross direction (CD) tensile strength of about 4.0 kg/in or greater.

A 4th embodiment is combination any of the above embodiments, wherein the support layer has a machine direction (MD) elongation percentage of greater than about 20.0%.

A 5th embodiment is combination any of the above embodiments, wherein the MD elongation percentage is about 30% or greater.

A 6th embodiment is combination any of the above embodiments, wherein the support layer has a cross direction (CD) elongation percentage of greater than about 20.0%.

A 7th embodiment is combination any of the above embodiments, wherein the CD elongation percentage is about 50% or greater.

An 8th embodiment is combination any of the above embodiments, wherein the membrane has an average burst pressure of at least about 12 psi to about 40 psi.

A 9th embodiment is combination any of the above embodiments, wherein the average burst pressure is at least about 35 psi.

A 10th embodiment is combination any of the above embodiments, wherein the membrane has a bubble point of about 4.5 to about 13.

An 11th embodiment is combination any of the above embodiments, wherein the membrane has an average flux of about 13 to about 15 gallons per square foot/day (gfd).

A 12th embodiment is combination any of the above embodiments, wherein the membrane has a percentage average rejection of at least about 99.5%.

A 13th embodiment is any combination of the above embodiments, wherein a ratio of a maximum pore diameter to a mean flow pore diameter of the support layer is about 3.0 to about 1.0.

An 14th embodiment is any combination of the above embodiments, wherein the ratio is about 2.5 to about 1.0.

A 15th embodiment is any combination of the above embodiments, wherein the ratio is about 1.5 to about 1.0.

A 16th embodiment is any combination of above 12 embodiments, wherein the substrate comprises a porous layer.

A 17th embodiment is any combination of above 13 embodiments, wherein the porous layer comprises polysulfone.

A 18th embodiment is any combination of the above embodiments, further comprising a barrier layer in contact with the porous layer such that the porous layer is disposed between the barrier layer and the support layer.

In another aspect, a filter is provided comprising the membrane of any combination of the above embodiments.

In another aspect, a first embodiment is a liquid filter comprising the membrane of any combination of the above embodiments.

A second embodiment is the first embodiment, wherein the filter is a reverse osmosis filter.

A third embodiment is any combination of the first two embodiments, further comprising a second membrane comprising a substrate and a support layer in contact with the substrate, wherein the support layer comprising continuous spunbond fibers.

A 4th embodiment is any combination of the above embodiments, further comprising a mesh layer disposed between the first and second membranes.

1. A membrane backer comprising:
a support layer comprising spunbond fibers,
wherein a ratio of a maximum pore diameter to a mean flow pore diameter of the support layer is about 8.0 or to about 1.0.

2. The backer of claim 1, wherein the ratio is about 1.5 to about 1.0.

3. The backer of claim 1, wherein the spunbond fibers are continuous fibers.

4. The backer of claim 1, wherein the support layer has a maximum pore diameter of about 25 microns or less.

5. The backer of claim 1, wherein the support layer has a mean flow pore diameter of about 10 microns or less.

6. The backer of claim 1, wherein the support layer has a minimum pore diameter of about 2 microns or less.

7. The backer of claim 1, wherein the spunbond fibers have a diameter of about 10 microns or less.

8. The backer of claim 1, wherein the support layer has a machine direction (MD) elongation percentage of greater than about 20.0%.

9. The backer of claim 1, wherein the support layer has a cross direction (CD) elongation percentage of greater than about 20.0%.

10. The backer of claim 1, wherein the spunbond fibers comprise PET.

11. The backer of claim 1 further comprising a second layer of fibers in contact with the support layer.

12. The backer of claim 11 wherein the second layer comprises meltblown fibers.

13. A membrane for use with a filter, the membrane comprising:
a substrate; and
a support layer in contact with the substrate, the support layer comprising continuous spunbond fibers.

14. The membrane of claim 13, wherein the support layer has a machine direction (MD) elongation percentage of greater than about 20.0%.

15. The membrane of claim 13 wherein the support layer has a cross direction (CD) elongation percentage of greater than about 20.0%.

16. The membrane of claim 13, wherein the membrane has an average burst pressure of at least about 12 psi to about 40 psi.

17. The membrane of claim 13, wherein the membrane has a bubble point of about 4.5 to about 13.

18. The membrane of claim 13, wherein the membrane has an average flux of about 13 to about 15 gallons per square foot/day (gfd).

19. The membrane of claim 13, wherein the membrane has a percentage average rejection of at least about 99.5%.

20. The membrane of claim 13, wherein the substrate comprises a porous polysulfone layer.
